(19) United States
(12) Patent Application Publication
(10) Pub. No.: US 2021/0129788 A1
(43) Pub. Date: May 6, 2021

(54) GAS GENERATOR, PLUG FOR GAS GENERATOR, AND METHOD OF MANUFACTURING PLUG FOR GAS GENERATOR

(71) Applicant: NIPPON KAYAKU KABUSHIKI KAISHA, Chiyoda-ku (JP)

(72) Inventors: Daisuke HAGIHARA, Himeji-shi (JP); Genya IIZUKA, Himeji-shi (JP)

(73) Assignee: NIPPON KAYAKU KABUSHIKI KAISHA, Chiyoda-ku (JP)

(21) Appl. No.: 16/473,708

(22) PCT Filed: Nov. 24, 2017
(86) PCT No.: PCT/JP2017/042208

§ 371 Date: Jun. 26, 2019

(30) Foreign Application Priority Data
Dec. 27, 2016 (JP) 2016-253322

(51) Int. Cl. B60R 21/264; B21J 5/02

(52) U.S. Cl. CPC B60R 21/2644; B60R 2021/26076; B21J 5/025

(57) ABSTRACT

A gas generator includes an elongated cylindrical housing main body and a plug which closes an axial end portion of the housing main body. The plug made of a metal includes a substantially columnar body portion, a first flange portion located on a side of a first end surface, and a second flange portion located on a side of a second end surface. An annular groove portion defined by the body portion, the first flange portion, and the second flange portion is located in a circumferential surface of the plug. A metal flow in a portion which appears in a surface layer of the circumferential surface of the plug including a surface of the annular groove portion continuously extends to reach the second end surface from the first end surface along the circumferential surface without discontinuity in the circumferential surface.

### TECHNICAL FIELD

The present invention relates to a gas generator and a plug for gas generator equipped therein (which is also simply referred to as a “plug” below) as well as a method of manufacturing the plug for gas generator and particularly to what is called a cylinder type gas generator having an elongated columnar outer geometry that is suitably incorporated into a side air bag apparatus and a plug for gas generator equipped therein as well as a method of manufacturing the plug for gas generator.

### BACKGROUND ART

From a point of view of protection of a driver and/or a passenger in a car and/or a pedestrian, an air bag apparatus has conventionally widely been used. The air bag apparatus is equipped for the purpose of protecting a driver and/or a passenger and/or a pedestrian against shock caused at the time of collision of a vehicle, and it receives a body of a driver or a passenger or a pedestrian with the air bag serving as a cushion by instantaneously expanding and developing the air bag at the time of collision of a vehicle.

A gas generator is equipment which is incorporated in this air bag apparatus, an igniter therein being ignited in response to power feed through a control unit at the time of collision of a vehicle to thereby burn a gas generating agent with flame caused by the igniter and instantaneously generate a large amount of gas, and thus expands and develops an air bag.

Depending on a position of installation in a vehicle and the like or on specifications such as output, gas generators of various constructions are available. A gas generator called a cylinder type gas generator represents one example. The cylinder type gas generator has an outer geometry in an elongated columnar shape and it is suitably incorporated in a side air bag apparatus, a curtain air bag apparatus, a knee air bag apparatus, or a seat cushion air bag apparatus.

Normally, in a cylinder type gas generator, an igniter is installed at one end portion in an axial direction of a housing, a combustion chamber accommodating a gas generating agent is provided on a side of the one end portion, a filter chamber accommodating a filter is provided on a side of the other end portion in the axial direction of the housing, and a gas discharge opening is provided in a circumferential wall portion of the housing in a portion defining the filter chamber.

In the cylinder type gas generator thus constructed, gas generated in the combustion chamber flows into the filter chamber along the axial direction of the housing and passes through the filter, and the gas which has passed through the filter is discharged to the outside through the gas discharge opening.

The housing of the cylinder type gas generator is often constituted of an elongated cylindrical housing main body, a holder which closes one axial end of the housing main body and to which the igniter described above is assembled, and a plug which closes the other axial end of the housing main body.

Generally, the plug is formed from a substantially disc-shaped member made of a metal, the member including a first end surface and a second end surface located as being opposed to each other and a circumferential surface connecting the first end surface and the second end surface to each other and being provided with an annular groove portion extending along a circumferential direction in the circumferential surface.

The plug thus constructed is inserted in above-described the other end of the housing main body and fixed by swaging to the housing main body by decreasing a diameter of the housing main body radially inward in a portion corresponding to the annular groove portion provided in the plug to engage the housing main body with the annular groove portion.

For example, Japanese Patent Laying-Open No. 2008-247301 (PTL 1), Japanese Patent Laying-Open No. 2010-247659 (PTL 2), and WO2010/079710 (PTL 3) disclose a cylinder type gas generator equipped with such a construction.

### CITATION LIST

### Patent Literature

PTL 1: Japanese Patent Laying-Open No. 2008-247301

PTL 2: Japanese Patent Laying-Open No. 2010-247659

PTL 3: WO2010/079710

### SUMMARY OF INVENTION

### Technical Problem

The plug described above is often manufactured by employing a slug obtained by punching a rolled plate made of stainless steel or iron steel as a material and subjecting the slug to forging and cutting stepwise as being combined.

Forging is performed for rough forming or finish-forming of the first end surface or the second end surface described above of the plug while strength of the plug is enhanced, and cutting is performed for forming the annular groove portion provided in the above-described circumferential surface of the plug. For example, according to WO2010/079710, a projection or a recess provided in an end surface of the plug can be formed by forging.

Cutting for forming the annular groove portion, however, may increase cost for manufacturing the plug. Specifically, cutting disadvantageously causes burrs at an end portion of the annular groove portion or adhesion of powdery chips to the plug. Therefore, a burr removal operation or a cleaning operation should separately be added, which leads to increase in manufacturing cost. Since cutting requires a relatively long cycle time, it leads to increase in manufacturing cost also in terms of productivity. Furthermore, since a forged plug is relatively high in strength, a cutting tool high in hardness is required for cutting the plug, which leads to higher cost of a manufacturing apparatus.

Therefore, the present invention was made in order to solve the problems described above, and an object thereof is to provide a plug for gas generator capable of achieving significantly lower manufacturing cost than in a conventional example while the plug is high in strength and a method of manufacturing the same as well as a gas generator including the plug for gas generator.

### Solution to Problem

A gas generator based on the present invention includes an elongated cylindrical housing main body provided with a gas discharge opening, a gas generating agent accommodated in the housing main body, a holder which closes one axial end of the housing main body, to which an igniter serving to burn the gas generating agent is assembled, and a plug which closes the other axial end of the housing main body. The plug is formed from a substantially disc-shaped member made of a metal, the member including a first end surface and a second end surface located as being opposed to each other and a circumferential surface connecting the first end surface and the second end surface to each other. The plug includes a substantially columnar body portion, a first flange portion projecting radially outward from an axial end portion of the body portion located on a side of the first end surface, and a second flange portion projecting radially outward from an axial end portion of the body portion located on a side of the second end surface. An annular groove portion defined by the body portion, the first flange portion, and the second flange portion is located in the circumferential surface. The plug is inserted in the other end of the housing main body such that any one of the first end surface and the second end surface faces the inside of the housing main body and the circumferential surface faces an inner circumferential surface of the housing main body, and fixed by swaging to the housing main body by decreasing a diameter of the housing main body radially inward in a portion corresponding to the annular groove portion to engage the housing main body with the annular groove portion. A metal flow in a portion which appears in a surface layer of the circumferential surface including a surface of the annular groove portion continuously extends to reach the second end surface from the first end surface along the circumferential surface without discontinuity in the circumferential surface.

In the gas generator based on the present invention, a recess may be provided in at least any one of the first end surface and the second end surface.

A plug for gas generator based on the present invention is substantially in a form of a disc and made of a metal, the plug including a first end surface and a second end surface located as being opposed to each other and a circumferential surface connecting the first end surface and the second end surface to each other. The plug includes a substantially columnar body portion, a first flange portion projecting radially outward from an axial end portion of the body portion located on a side of the first end surface, and a second flange portion projecting radially outward from an axial end portion of the body portion located on a side of the second end surface. An annular groove portion defined by the body portion, the first flange portion, and the second flange portion is located in the circumferential surface. A metal flow in a portion which appears in a surface layer of the circumferential surface including a surface of the annular groove portion continuously extends to reach the second end surface from the first end surface along the circumferential surface without discontinuity in the circumferential surface.

In the plug for gas generator based on the present invention, a recess may be provided in at least any one of the first end surface and the second end surface.

A method of manufacturing a plug for gas generator based on the present invention is a method for manufacturing a plug for gas generator in a form of a disc made of a metal, the plug including a first end surface and a second end surface located as being opposed to each other and a circumferential surface connecting the first end surface and the second end surface to each other, the plug being provided with an annular groove portion extending along a circumferential direction in the circumferential surface. The method includes forming a substantially columnar blank material by cutting a rolled wire rod as intersecting with an axial direction, sizing the blank material, and providing the annular groove portion in a circumferential surface of the sized blank material. The providing the annular groove portion includes finish-forming a first end portion representing one axial end portion of the blank material and including the first end surface by forming a first flange portion projecting radially outward in the first end portion by fluidizing the first end portion under pressure and finish-forming a second end portion representing the other axial end portion of the blank material and including the second end surface by forming a second flange portion projecting radially outward in the second end portion by fluidizing the second end portion under pressure while a plurality of forming dice divided in a circumferential direction are applied to the circumferential surface of the blank material after finish-forming of the first end portion.

In the method of manufacturing a plug for gas generator based on the present invention, the providing the annular groove portion may further include roughly forming the first end portion by providing a first depression portion having an axial direction of the blank material as a direction of depth in the first end portion by fluidizing the first end portion of the blank material under pressure before finish-forming of the first end portion, and in that case, the first end portion is preferably finish-formed by fluidizing the first end portion under pressure by using a forming die having a protrusion which can be inserted into the first depression portion in the finish-forming a first end portion.

In the method of manufacturing a plug for gas generator based on the present invention, the providing the annular groove portion may further include roughly forming the second end portion by providing a second depression portion having an axial direction of the blank material as a direction of depth in the second end portion by fluidizing the second end portion of the blank material under pressure before finish-forming of the second end portion, and in that case, the second end portion is preferably finish-formed by fluidizing the second end portion under pressure by using a forming die having a protrusion which can be inserted into the second depression portion in the finish-forming a second end portion.

In the method of manufacturing a plug for gas generator based on the present invention, the sizing the blank material and the providing the annular groove portion are preferably performed by heading.

In the method of manufacturing a plug for gas generator based on the present invention, the forming a blank material, the sizing the blank material, and the providing the annular groove portion are preferably performed by using a single multistep heading machine.

### Advantageous Effects of Invention

According to the present invention, a plug for gas generator capable of achieving significantly lower manufacturing cost than in a conventional example while the plug is high in strength and a method of manufacturing the same as well as a gas generator including the plug for gas generator can be provided.

### BRIEF DESCRIPTION OF DRAWINGS

FIG. 1 is a schematic diagram of a cylinder type gas generator in a first embodiment of the present invention.

FIG. 2 is an enlarged cross-sectional view of the vicinity of an igniter of the cylinder type gas generator shown in FIG. 1.

FIG. 3 is an enlarged cross-sectional view of the vicinity of a plug of the cylinder type gas generator shown in FIG. 1.

FIG. 4 is a flowchart showing a method of manufacturing a plug for gas generator in the first embodiment of the present invention.

FIG. 5 is a schematic cross-sectional view of a step of sizing a blank material shown in FIG. 4.

FIG. 6 is a schematic cross-sectional view of a step of roughly forming an inner end portion of the blank material shown in FIG. 4.

FIG. 7 is a schematic cross-sectional view of a step of finish-forming an outer end portion of the blank material shown in FIG. 4.

FIG. 8 is a schematic cross-sectional view of a step of finish-forming the inner end portion of the blank material shown in FIG. 4.

FIG. 9 is a diagram schematically showing how a metal flow appears in a cross-section of the plug for gas generator in the first embodiment of the present invention.

FIG. 10 is an enlarged cross-sectional view of the vicinity of a plug for cylinder type gas generator according to a first modification.

FIG. 11 is an enlarged cross-sectional view of the vicinity of a plug for cylinder type gas generator according to a second modification.

FIG. 12 is an enlarged cross-sectional view of the vicinity of a plug for cylinder type gas generator according to a third modification.

FIG. 13 is an enlarged cross-sectional view of the vicinity of a plug of cylinder type gas generator in a second embodiment of the present invention.

### DESCRIPTION OF EMBODIMENTS

An embodiment of the present invention will be described hereinafter in detail with reference to the drawings. An embodiment shown below represents application of the present invention to a cylinder type gas generator incorporated in a side air bag apparatus and a plug for gas generator equipped therein as well as a method of manufacturing the plug for gas generator. The same or common elements in an embodiment shown below have the same reference characters allotted in the drawings and description thereof will not be repeated.

### First Embodiment

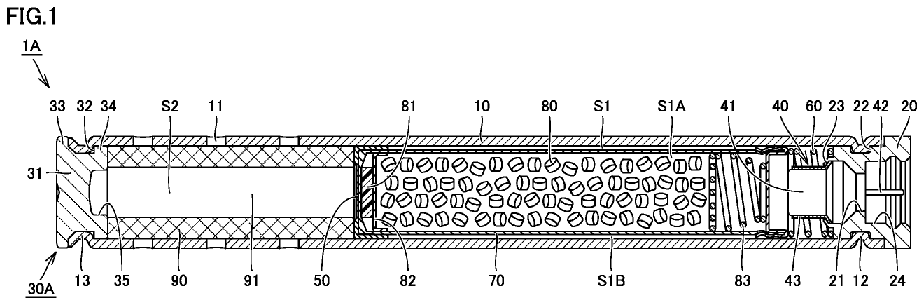

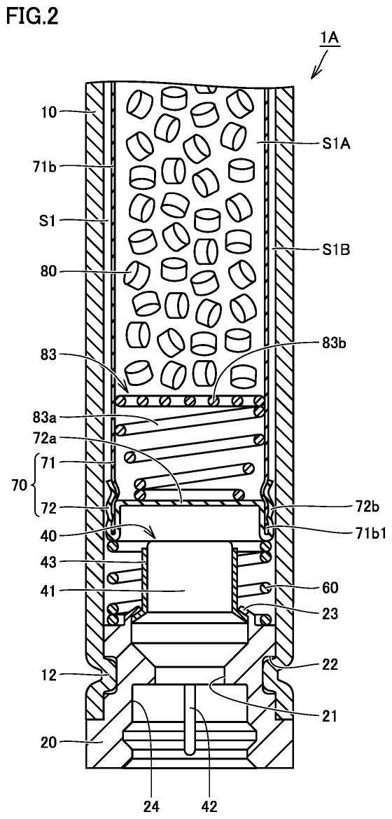

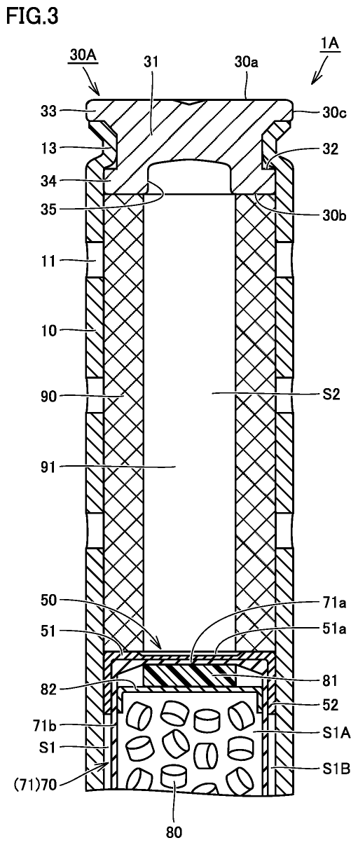

FIG. 1 is a schematic diagram of a cylinder type gas generator in a first embodiment of the present invention. FIGS. 2 and 3 are an enlarged cross-sectional view of the vicinity of an igniter and an enlarged cross-sectional view of the vicinity of a plug, of the cylinder type gas generator shown in FIG. 1, respectively. A construction of a cylinder type gas generator 1A and a plug for gas generator 30A equipped therein in the present embodiment will initially be described with reference to FIGS. 1 to 3.

As shown in FIGS. 1 to 3, cylinder type gas generator 1A in the present embodiment has an elongated columnar outer geometry and has an elongated cylindrical housing having closed one and the other end portions located in an axial direction. The housing includes a housing main body 10, a holder 20, and plug 30A.

An igniter 40, a partition member 50, a coil spring 60, a gastight container 70, a gas generating agent 80, an autoignition agent 81, a division member 82, a coil spring 83, and a filter 90 as internal components are accommodated in the housing constituted of housing main body 10, holder 20, and plug 30A. In the housing, a combustion chamber S1 where gas generating agent 80 among the internal components described above is mainly arranged and a filter chamber S2 where filter 90 is arranged are located.

Housing main body 10 is made of an elongated cylindrical member which implements a circumferential wall portion of the housing and has an opening provided at each of opposing ends in the axial direction. Holder 20 is formed from a cylindrical member including a through portion 21 which extends in a direction the same as the axial direction of housing main body 10, and includes in its outer circumferential surface, an annular groove portion 22 for fixing by swaging which will be described later. Plug 30A is formed from a member in a shape of a disc having a prescribed thickness and includes in its circumferential surface 30c (see, in particular, FIG. 3), an annular groove portion 32 for fixing by swaging which will be described later. Annular groove portions 22 and 32 for fixing by swaging are provided in the outer circumferential surface of holder 20 and circumferential surface 30c of plug 30A, respectively, as extending in the circumferential direction.

Housing main body 10 may be formed from a member made of a metal such as stainless steel, iron steel, an aluminum alloy, or a stainless alloy or from a cylindrically formed press-formed product by press-working of a rolled steel plate represented by SPCE. Alternatively, housing main body 10 may be formed from an electric resistance welded tube represented by STKM.

In particular, when housing main body 10 is formed from a press-formed product of a rolled steel plate or an electric resistance welded tube, housing main body 10 can be formed more inexpensively and readily and with much lighter weight than when the housing main body is formed from a member made of a metal such as stainless steel or iron steel.

Holder 20 and plug 30A are formed from a member made of a metal such as stainless steel, iron steel, an aluminum alloy, or a stainless alloy. In particular, plug 30A is formed by employing a rolled wire rod made of a metal composed of various types of materials described above as a material and performing a plurality of times of heading which will be described later as being combined stepwise, and more specifically, it is formed into a desired shape by repeating fluidization under pressure by performing such heading stepwise.

Holder 20 is fixed to housing main body 10 so as to close one axial opening end of housing main body 10. Specifically, while holder 20 is inserted in one opening end of housing main body 10, housing main body 10 in a portion corresponding to annular groove portion 22 provided in the outer circumferential surface of holder 20 is engaged with annular groove portion 22 as being decreased in diameter radially inward, so that holder 20 is fixed by swaging to housing main body 10. Thus, one axial end portion of the housing is implemented by holder 20.

Plug 30A is fixed to housing main body 10 so as to close the other axial opening end of housing main body 10. Specifically, while plug 30A is inserted in the other opening end of housing main body 10, housing main body 10 in a portion corresponding to annular groove portion 32 provided in circumferential surface 30c of plug 30A is engaged with annular groove portion 32 as being decreased in diameter radially inward so that plug 30A is fixed by swaging to housing main body 10. The other axial end portion of the housing is thus implemented by plug 30A.

Such fixing by swaging substantially uniformly decreases a diameter of housing main body 10 radially inward and what is called six-directional or eight-directional swaging can be made use of By performing such fixing by swaging, swaging portions 12 and 13 are provided in housing main body 10. Swaging portions 12 and 13 are thus in direct contact with annular groove portions 22 and 32, respectively, so that a gap is prevented from being provided therebetween. A structure for assembly of holder 20 to housing main body 10 is not limited to the assembly structure described above, and another assembly structure may be adopted.

As shown in FIGS. 1 and 3, plug 30A is formed from a member in a form of a disc as described above, and includes an outer end surface 30a and an inner end surface 30b in addition to circumferential surface 30c described above. Outer end surface 30a and inner end surface 30b correspond to a pair of end surfaces located as being opposed to each other in the axial direction of plug 30A. In the present embodiment, outer end surface 30a corresponds to the first end surface and inner end surface 30b corresponds to the second end surface.

Outer end surface 30a is located to face the outside of housing main body 10 and inner end surface 30b is located to face the inside of housing main body 10. Circumferential surface 30c connects outer end surface 30a and inner end surface 30b to each other and is located to face an inner circumferential surface of housing main body 10.

Plug 30A includes a substantially columnar body portion 31, an outer flange portion 33 as a first flange portion projecting radially outward from an axial end portion of body portion 31 located on a side of outer end surface 30a, and an inner flange portion 34 as a second flange portion projecting radially outward from an axial end portion of body portion 31 located on a side of inner end surface 30b.

Thus, above-described annular groove portion 32 for fixing by swaging defined by body portion 31, outer flange portion 33, and inner flange portion 34 is located in circumferential surface 30c in a portion of plug 30A located substantially in the center in the axial direction. A surface of annular groove portion 32 (that is, a bottom surface and a side surface of annular groove portion 32 which define annular groove portion 32) is included in circumferential surface 30c.

Outer flange portion 33 is constructed to be larger in outer diameter than inner flange portion 32. More specifically, the outer diameter of outer flange portion 33 is substantially equal to an outer diameter of housing main body 10 in a portion other than portions where swaging portions 12 and 13 are formed, and the outer diameter of inner flange portion 34 is substantially equal to an inner diameter of housing main body 10 in the portion other than the portions where swaging portions 12 and 13 are formed.

A recess 35 is located in a central portion of inner end surface 30b of plug 30A. Recess 35 is a portion provided collaterally to forming of plug 30A by performing a plurality of times of heading which will be described later as being combined stepwise, and has also a function to collect residues generated as a result of burning of gas generating agent 80. This function will be described later.

As shown in FIGS. 1 and 2, igniter 40 is assembled to above-described one axial end portion of the housing by being supported by holder 20. Igniter 40 serves to burn gas generating agent 80 and is set to face a space in the housing.

Igniter 40 includes an ignition portion 41 and a pair of terminal pins 42. In ignition portion 41, a resistor (bridge wire) is attached to be connected to the pair of terminal pins 42, and an ignition agent is loaded in ignition portion 41 so as to surround the resistor or to be in contact with the resistor. An enhancer agent may be loaded in ignition portion 41 as necessary.

Here, a Nichrome wire or a resistance wire made of an alloy containing platinum and tungsten is generally used as a resistor, and ZPP (zirconium potassium perchlorate), ZWPP (zirconium tungsten potassium perchlorate), lead tricinate, or the like is generally made use of as the ignition agent. A composition composed of metal powders/oxidizing agent represented by B/KNO₃, B/NaNO₃, or Sr(NO₃)₂, a composition composed of titanium hydride/potassium perchlorate, or a composition composed of B/5-aminotetrazole/potassium nitrate/molybdenum trioxide is employed as the enhancer agent. A squib cup defining an outer surface of ignition portion 41 is generally made of a metal or plastic.

Upon sensing collision, a prescribed amount of current flows in a resistor through terminal pin 42. As the prescribed amount of current flows in the resistor, Joule heat is generated in the resistor and the ignition agent starts burning. Thermal particles at a high temperature caused by burning burst a squib cup accommodating the ignition agent. A time period from flow of a current in the resistor until activation of igniter 40 is generally not longer than 2 milliseconds in a case that the Nichrome wire is employed as the resistor.

A combustion control cover 43 in a substantially cylindrical shape made of a metal is externally attached to ignition portion 41 of igniter 40. Combustion control cover 43 serves to efficiently guide thermal particles generated in igniter 40 at the time of activation to gas generating agent 80, and more specifically, it gives directivity to a direction of travel of thermal particles generated in ignition portion 41 of igniter 40.

Specifically, ignition portion 41 is surrounded by combustion control cover 43, so that an opening is provided mainly at a tip end portion located on a side of gas generating agent 80 of a squib cup defining an outer surface of ignition portion 41 when the squib cup bursts. Accordingly, a direction of travel of thermal particles generated in ignition portion 41 is restricted to the axial direction of housing main body 10.

Therefore, by providing combustion control cover 43 as described above, thermal particles generated in igniter 40 can efficiently be guided to gas generating agent 80.

Igniter 40 and combustion control cover 43 are fixed to holder 20 by a swaging portion 23 provided in holder 20. More specifically, holder 20 includes swaging portion 23 for fixing by swaging of igniter 40 and combustion control cover 43 at the axial end portion which faces a space in the housing. Swaging portion 23 described above is swaged while igniter 40 to which combustion control cover 43 is attached is inserted in through portion 21 and abuts on a wall portion in a portion defining through portion 21 of holder 20, so that igniter 40 and combustion control cover 43 are fixed to holder 20 as being held by holder 20.

A recess 24 continuous to through portion 21 described above is provided at the axial end portion of holder 20 exposed to the outside. Recess 24 provides a female connector portion which receives a male connector (not shown) of a harness for connecting igniter 40 and a control unit (not shown) to each other, and a portion close to a tip end of terminal pin 42 of igniter 40 is located as being exposed in recess 24. A male connector is inserted in recess 24 serving as the female connector portion so that electrical conduction between a core of the harness and terminal pin 42 is achieved.

As shown in FIGS. 1 and 3, partition member 50 is arranged at a prescribed position in the space in the housing. Partition member 50 is a member for partitioning the space in the housing into combustion chamber S1 and filter chamber S2 in the axial direction.

Partition member 50 is in a shape of a cylinder with bottom, and formed from a member made of a metal such as stainless steel, iron steel, an aluminum alloy, or a stainless alloy. Partition member 50 includes a separation wall portion 51 in a form of a flat plate arranged to be orthogonal to the axial direction of housing main body 10 and an annular wall portion 52 in a form of a cylindrical wall erected from a circumferential edge of separation wall portion 51. Partition member 50 is arranged such that a main surface on an outer side of separation wall portion 51 abuts on filter 90 and an outer circumferential surface of annular wall portion 52 abuts on the inner circumferential surface of housing main body 10.

A score 51a is provided in a main surface of separation wall portion 51 which abuts on filter 90. Score 51a serves to provide an opening as a result of cleavage of separation wall portion 51 with increase in internal pressure in combustion chamber S1 as a result of burning of gas generating agent 80, and it is provided, for example, as a plurality of grooves provided to radially intersect with one another. Score 51a is provided in a portion in filter 90 opposed to a hollow portion 91.

As shown in FIGS. 1 to 3, in a space (that is, combustion chamber S1) lying between holder 20 and partition member 50 in the space in the housing, coil spring 60 and gastight container 70 are arranged. In a gas generating agent accommodation chamber S1A which is a space in gastight container 70, gas generating agent 80, autoignition agent 81, division member 82, and coil spring 83 are accommodated.

Gastight container 70 serves to seal gas generating agent 80 accommodated therein, and it is formed from a weak member which melts or bursts with heat or a pressure generated by activation of igniter 40. Gastight container 70 is in a substantially cylindrical shape having opposing ends closed and arranged substantially coaxially with the housing.

More specifically, gastight container 70 includes a cup body 71 and a cover body 72, and gas generating agent accommodation chamber S1A described above is defined in gastight container 70 by joining cup body 71 and cover body 72 to each other. What is called tightening by winding is used for joining cup body 71 and cover body 72.

More specifically, cup body 71 includes a top wall portion 71a in a form of a flat plate and a cylindrical sidewall portion 71b which extends from a circumferential edge of top wall portion 71a. Cover body 72 includes a bottom portion 72a in a form of a flat plate located in cup body 71 by being inserted in an opening end 71b1 of cup body 71 and a fold-over portion 72b which extends from a circumferential edge of bottom portion 72a and is partly curved to cover an inner circumferential surface, an end surface, and an outer circumferential surface of opening end 71b1 of cup body 71.

As fold-over portion 72b provided in cover body 72 holds opening end 71b1 of cup body 71, cup body 71 and cover body 72 are joined to each other by tightening by winding. Gas generating agent accommodation chamber S1A described above is mainly defined by top wall portion 71a and sidewall portion 71b of cup body 71 and bottom portion 72a of cover body 72.

Various joint methods such as brazing, adhesion, and welding in addition to tightening by winding are available for joint between cup body 71 and cover body 72.

Gastight container 70 is inserted in housing main body 10 such that top wall portion 71a of cup body 71 is located on a side of partition member 50 and bottom portion 72a of cover body 72 is located on a side of holder 20. Bottom portion 72a of cover body 72 thus faces ignition portion 41 of igniter 40.

More specifically, the end portion of gastight container 70 on a side where top wall portion 71a is located is fitted into partition member 50 by being inserted into the inside of partition member 50 and an end portion on a side where bottom portion 72a of gastight container 70 is located is loosely fitted to housing main body 10. Gastight container 70 is thus fixed as being positioned with respect to housing main body 10 and arranged at a prescribed distance from the inner circumferential surface of housing main body 10.

Therefore, a heat insulating layer S1B which is a space of a prescribed size is provided between housing main body 10 forming the circumferential wall portion of the housing and sidewall portion 71b of gastight container 70, and heat insulating layer S1B extends substantially cylindrically along the axial direction of combustion chamber S1.

According to such a construction, increase in temperature of gas generating agent 80 due to external heating even in case of fire in a vehicle equipped with an air bag apparatus incorporating cylinder type gas generator 1A can effectively be suppressed.

By providing heat insulating layer S1B in a portion radially outside gastight container 70 where gas generating agent 80 is accommodated, heat insulating layer S1B serves as a thermal resistance and heat of housing main body 10 is less likely to conduct to gas generating agent 80, and consequently, increase in temperature of gas generating agent 80 can be suppressed.

Heat insulating layer S1B is preferably lower in thermal conductivity than housing main body 10, and it is provided as an air layer in the present embodiment. Heat insulating layer S1B, however, does not necessarily have to be provided as the air layer, and it may be provided as a gas layer filled with another gas or as a vacuum layer. In addition, heat insulating layer S1B may be provided by arranging various heat insulating members in the space.

In gas generating agent accommodation chamber S1A provided in gastight container 70, autoignition agent 81 and division member 82 are arranged at the end portion on the side of partition member 50 and coil spring 83 is arranged at the end portion on the side of holder 20. Gas generating agent 80 is arranged in a portion except for the end portion on the side of partition member 50 and the end portion on the side of holder 20 in gas generating agent accommodation chamber S1A provided in gastight container 70.

Division member 82 is a member for dividing gas generating agent accommodation chamber S1A in the axial direction. Division member 82 is formed from a relatively weak member so as to burst or melt with burning of gas generating agent 80 at the time of activation. The division member is formed from a member in a shape of a cup made from a press-formed product made of a metal such as copper, aluminum, a copper alloy, an aluminum alloy, or the like.

Division member 82 is located as being in contact with both of gas generating agent 80 and autoignition agent 81 and as being held thereby. An outer circumferential surface of division member 82 preferably abuts on sidewall portion 71b of gastight container 70.

Gas generating agent 80 is an agent which is ignited by thermal particles generated as a result of activation of igniter 40 and produces gas as it burns. A non-azide-based gas generating agent is preferably employed as gas generating agent 80, and gas generating agent 80 is formed as a molding generally containing a fuel, an oxidizing agent, and an additive.

For the fuel, for example, a triazole derivative, a tetrazole derivative, a guanidine derivative, an azodicarbonamide derivative, a hydrazine derivative, or the like, or combination thereof is made use of. Specifically, for example, nitroguanidine, guanidine nitrate, cyanoguanidine, 5-aminotetrazole, and the like are suitably made use of.

As the oxidizing agent, for example, basic nitrate such as basic copper nitrate, perchlorate such as ammonium perchlorate or potassium perchlorate, nitrate containing cations selected from an alkali metal, an alkali earth metal, a transition metal, and ammonia, or the like is made use of. As the nitrate, for example, sodium nitrate, potassium nitrate, or the like is suitably made use of.

As the additive, a binder, a slag formation agent, a combustion modifier, or the like is exemplified. As the binder, for example, an organic binder such as metal salt of carboxymethyl cellulose and stearate, or an inorganic binder such as synthetic hydrotalcite and Japanese acid clay can suitably be made use of. As the slag formation agent, silicon nitride, silica, Japanese acid clay, or the like can suitably be made use of. As the combustion modifier, a metal oxide, ferrosilicon, activated carbon, graphite, or the like can suitably be made use of.

A shape of a molding of gas generating agent 80 includes various shapes such as a particulate shape including a granule, a pellet, and a column, and a disc shape. Among columnar moldings, a molding with holes having through holes in the molding (such as a cylindrical shape with a single hole or a cylindrical shape with multiple holes) is also made use of. These shapes are preferably selected as appropriate depending on specifications of an air bag apparatus in which cylinder type gas generator 1A is incorporated, and for example, a shape optimal for the specifications is preferably selected by selecting a shape allowing change over time of a rate of generation of gas during burning of gas generating agent 80. Furthermore, in addition to a shape of gas generating agent 80, a size of a molding or an amount thereof for filling is preferably selected as appropriate, in consideration of a linear burning velocity, a pressure exponent, or the like of gas generating agent 80.

Autoignition agent 81 is an agent which self-ignites without depending on activation of igniter 40, and arranged to abut on top wall portion 71a of gastight container 70. More specifically, autoignition agent 81 is made of pellets formed in a columnar shape of a flat profile and comes in contact with top wall portion 71a of gastight container 70 and division member 82 as being held by top wall portion 71a and division member 82.

Autoignition agent 81 is an agent lower in spontaneous combustion temperature than gas generating agent 80, and it serves not to induce an abnormal operation due to external heating of cylinder type gas generator 1A in case of fire in a vehicle equipped with an air bag apparatus incorporating cylinder type gas generator 1A.

Autoignition agent 81 is in thermal contact with housing main body 10 substantially through a shortest path with division member 82 which is a member made of a metal, the end portion close to top wall portion 71a of gastight container 70 which is a member made of a metal, and partition member 50 which is a member made of a metal being interposed. Therefore, autoignition agent 81 is efficiently heated in case of fire.

Therefore, timing of exhibition of an autoignition operation started as a result of spontaneous ignition of autoignition agent 81 in case of fire in a vehicle becomes earlier, and consequently a temperature of gas generating agent 80 at the time when the autoignition operation is exhibited can relatively be suppressed. Therefore, increase in internal pressure in the housing at the time of the autoignition operation can significantly be suppressed.

Thus, not only break of the housing can more reliably be prevented but also a withstanding pressure required of the housing can further be suppressed. Consequently, the housing can be smaller in thickness (in particular, a thickness of housing main body 10) and cylinder type gas generator 1A can also be reduced in size and weight as compared with the conventional example.

Coil spring 83 is provided for the purpose of preventing gas generating agent 80 made of a molding from being crushed by vibration or the like, and has a spring portion 83a formed by bending a metal wire rod and a pressing portion 83b. Spring portion 83a is arranged such that one end thereof abuts on bottom portion 72a of gastight container 70 and pressing portion 83b is formed at the other end. Pressing portion 83b is provided by arranging, for example, metal wire rods substantially in parallel to each other at a prescribed interval, and abuts on gas generating agent 80.

Thus, gas generating agent 80 is elastically biased toward partition member 50 by coil spring 83 and prevented from moving in gastight container 70. Instead of coil spring 83 as described above, a cushion material formed from a member made, for example, of a molding of ceramic fibers, rock wool, a foamed resin (such as foamed silicone, foamed polypropylene, or foamed polyethylene), or rubber represented by chloroprene and EPDM may be made use of.

In a space in combustion chamber S1 located on the side of holder 20 relative to gastight container 70, coil spring 60 representing an elastic body which is a component different from coil spring 83 described above is arranged. Coil spring 60 is a member for accommodating dimension variation among various constituent components accommodated in the housing, and unlike coil spring 83 described above, it is formed from a general spring member without pressing portion 83b as provided in coil spring 83.

More specifically, coil spring 60 is arranged such that one end thereof abuts on holder 20 and the other end abuts on a tip end of fold-over portion 72b located at the end portion of gastight container 70 on the side of holder 20. Gastight container 70 is thus elastically biased toward partition member 50 by coil spring 60 and fixed to the housing by being sandwiched between partition member 50 described above and coil spring 60.

Gastight container 70 may be fixed to the housing by another elastic body such as a cushion material formed from a member made, for example, of a molding of ceramic fibers, rock wool, a foamed resin (such as foamed silicone, foamed polypropylene, or foamed polyethylene), or rubber represented by chloroprene and EPDM instead of coil spring 60 as described above.

As shown in FIGS. 1 and 3, in the space in the housing, filter 90 is arranged in the space (that is, filter chamber S2) lying between plug 30A and partition member 50. Filter 90 is formed from a cylindrical member having hollow portion 91 extending in a direction the same as the axial direction of housing main body 10, and has axial one end surface abutting on plug 30A and axial the other end surface abutting on partition member 50. Hollow portion 91 of filter 90 faces recess 35 in plug 30A.

Filter 90 functions as cooling means for cooling gas by removing heat from the gas at a high temperature when the gas produced as a result of burning of gas generating agent 80 passes through this filter 90 and also functions as removal means for removing residues or the like contained in the gas. As described above, by making use of filter 90 formed from a cylindrical member, a flow resistance against gas which flows through filter chamber S2 at the time of activation is suppressed and an efficient flow of the gas can be achieved.

A filter formed from an aggregate of metal wire rods or metal mesh materials suitably made of stainless steel or iron steel can be made use of as filter 90. Specifically, a wire gauze of stocking stitch, a plain-woven wire gauze, an aggregate of crimped metal wire rods, or a material obtained by compressing the former with the use of a press can be made use of.

Alternatively, a material obtained by winding a perforated metal plate can also be made use of as filter 90. In this case, as the perforated metal plate, for example, expanded metal obtained by making staggered cuts in a metal plate and providing holes by widening the cuts to thereby work the metal plate in a mesh, hook metal obtained by perforating a metal plate and collapsing burrs caused around a periphery of the hole for flattening, or the like can be made use of.

A plurality of gas discharge openings 11 are provided along the circumferential direction and the axial direction in housing main body 10 in a portion defining filter chamber S2. The plurality of gas discharge openings 11 serve for guiding gas which has passed through filter 90 to the outside of the housing.

An operation of cylinder type gas generator 1A in the present embodiment when it is activated will now be described with reference to FIG. 1.

With reference to FIG. 1, when a vehicle on which cylinder type gas generator 1A in the present embodiment is mounted collides, collision is sensed by collision sensing means separately provided in the vehicle and igniter 40 is activated based thereon by current feed caused by a control unit separately provided in the vehicle.

When igniter 40 is activated, an ignition agent or an enhancer agent in addition thereto burns. Then, a pressure in ignition portion 41 increases, which bursts ignition portion 41, and thermal particles flow to the outside of ignition portion 41.

Combustion control cover 43 described above provides directivity to thermal particles which flow out of ignition portion 41, so that the thermal particles thus reach bottom portion 72a of gastight container 70. Accordingly, bottom portion 72a of gastight container 70 melts or bursts with heat or a pressure generated by activation of igniter 40 and the thermal particles described above reach gas generating agent 80.

The thermal particles which have reached gas generating agent 80 burn gas generating agent 80 so that a large amount of gas is produced. Accordingly, a pressure and a temperature in gas generating agent accommodation chamber S1A increase, sidewall portion 71b of gastight container 70 and division member 82 burst or melt and autoignition agent 81 burns, and furthermore top wall portion 71a of gastight container 70 bursts or melts.

As gas generating agent 80 burns, a pressure in the entire combustion chamber S1 further increases and an internal pressure in combustion chamber S1 reaches a prescribed pressure. Thus, a portion of partition member 50 where score 51a is provided ruptures. Thus, a communication hole is provided in partition member 50 in a portion opposed to hollow portion 91 of filter 90, and combustion chamber S1 and filter chamber S2 communicate with each other through the communication hole.

Accordingly, gas produced in combustion chamber S1 flows into filter chamber S2 through a communication hole provided in partition member 50. The gas which has flowed into filter chamber S2 flows along the axial direction through hollow portion 91 of filter 90, thereafter changes its direction toward a radial direction, and passes through filter 90. At that time, heat is removed through filter 90 and the gas is cooled, and residues contained in the gas are removed by filter 90.

Gas which has flowed along the axial direction through hollow portion 91 of filter 90 is blown against recess 35 in plug 30A. Therefore, residues contained in the gas adhere to the surface of recess 35 and effectively collected therein. Thus, the function of recess 35 described above to collect residues is exhibited.

The gas which has passed through filter 90 is discharged to the outside of the housing through gas discharge opening 11. The discharged gas is introduced into an air bag provided adjacently to cylinder type gas generator 1A to thereby expand and develop the air bag.

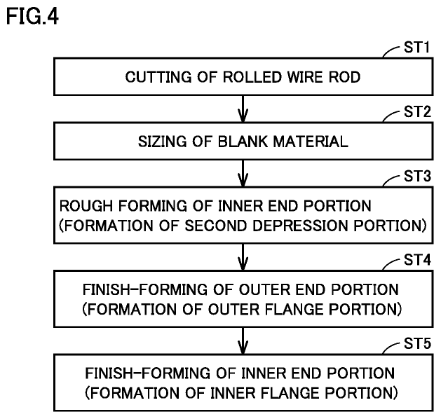

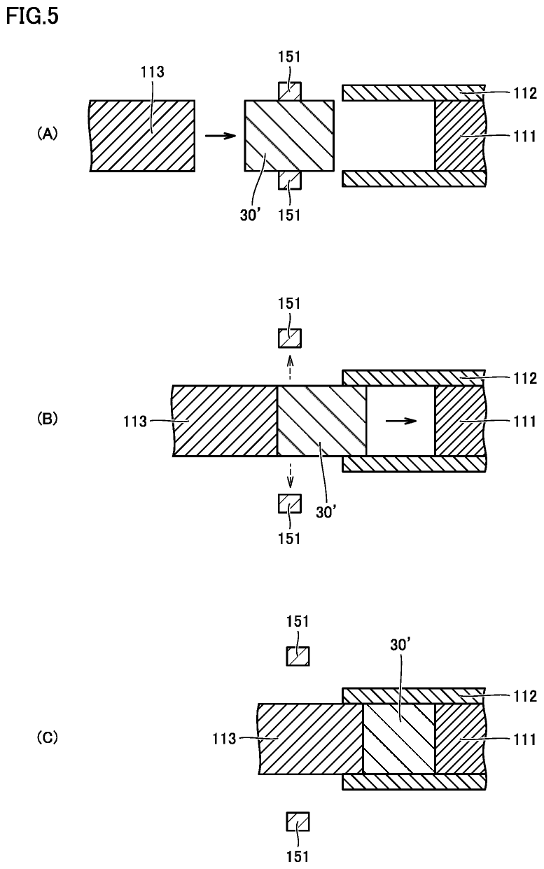

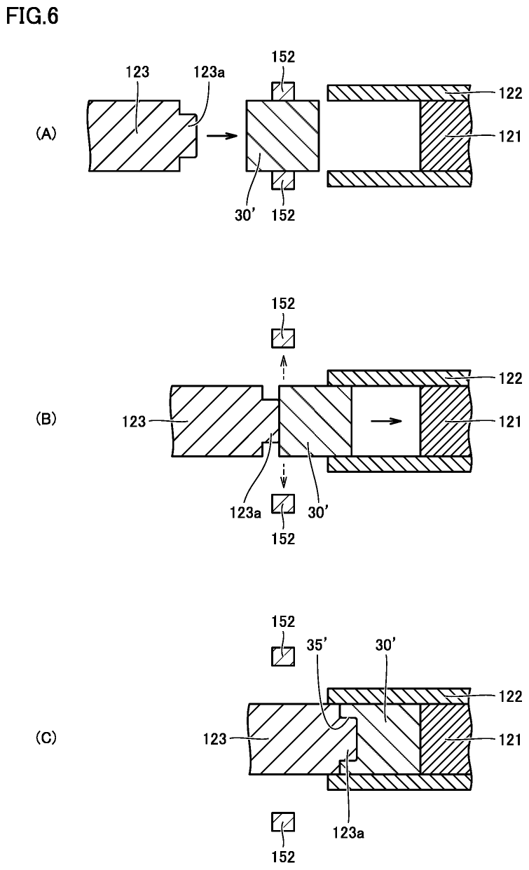

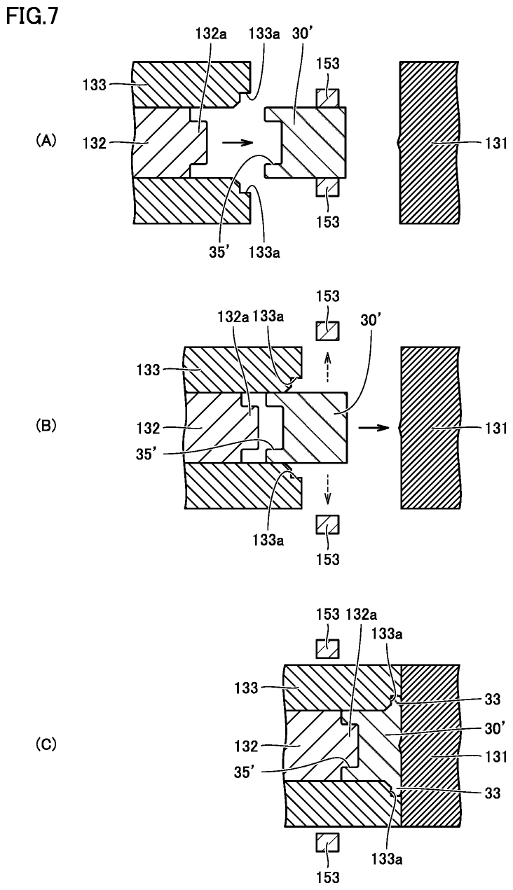

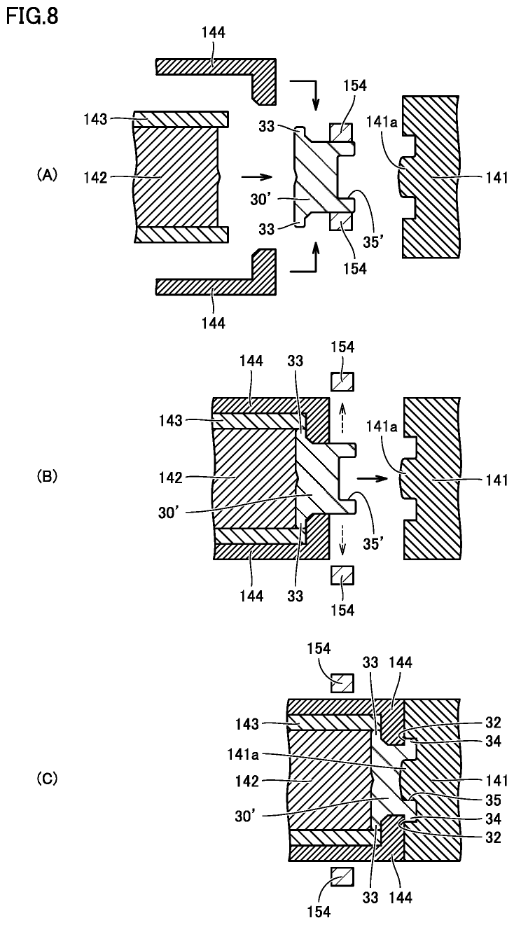

FIG. 4 is a flowchart showing a method of manufacturing a plug for gas generator in the present embodiment. FIG. 5 is a schematic cross-sectional view of a step of sizing a blank material shown in FIG. 4. FIG. 6 is a schematic cross-sectional view of a step of roughly forming an inner end portion of the blank material shown in FIG. 4. FIG. 7 is a schematic cross-sectional view of a step of finish-forming an outer end portion of the blank material shown in FIG. 4. FIG. 8 is a schematic cross-sectional view of a step of finish-forming the inner end portion of the blank material shown in FIG. 4. A method of manufacturing a plug for gas generator in the present embodiment will now be described with reference to FIGS. 4 to 8.

As described above, plug for gas generator 30A in the present embodiment is formed by a plurality of times of heading as being combined stepwise. More suitably, the plug for gas generator is formed by using a single multistep heading machine (what is called a former). Heading represents one type of cold forging, and refers to forming of a work material by fluidization under pressure by horizontally applying a pressure to a work material by using a die and a punch serving as forming dice. The method of manufacturing a plug for gas generator described below shows an example using a single multistep heading machine and a specific procedure is as set forth below.

Initially, as shown in FIG. 4, in step ST1, a rolled wire rod is cut. As described above, a rolled wire rod (what is called a coil material) composed of stainless steel, iron steel, an aluminum alloy, or a stainless alloy is employed as the rolled wire rod. The rolled wire rod is cut by cutting of a rolled wire rod drawn into the multistep heading machine by a cutting edge in a direction orthogonal to the rolled wire rod.

A columnar member having a prescribed length is thus formed as a work material (what is called a blank material). In the description below, a work material subjected to all types of working until completion of manufacturing of plug 30A is referred to as a blank material without being particularly distinguished.

Then, as shown in FIG. 4, in step ST2, the blank material is sized. As shown in FIG. 5 (A) to (C), forming dice 111 and 112 as dice and a forming die 113 as a punch are used for sizing of a blank material 30′.

Specifically, initially, as shown in FIG. 5 (A), blank material 30′ formed in step ST1 is arranged between forming dice 111 and 112 and forming die 113 as being held by a catch 151 of a transfer mechanism. Blank material 30′ is arranged such that its axial direction extends along a direction of alignment of forming dice 111 and 112 and forming die 113.

Then, as shown in FIG. 5 (B), forming die 113 starts to move toward blank material 30′ as it is driven, presses one axial end surface of blank material 30′, and transfers blank material 30′ toward forming dice 111 and 112. Blank material 30′ is released as catch 151 retracts at the time point of insertion of blank material 30′ into an inner space defined by forming dice 111 and 112.

Then, as shown in FIG. 5 (C), forming die 113 further moves toward blank material 30′ so that the other axial end surface of blank material 30′ is in contact with forming die 111 and blank material 30′ lies between forming dice 111 to 113. Pressing force is thus applied to blank material 30′ by forming dice 111 to 113. Compressive force mainly along the axial direction is applied to blank material 30′ at this time so that blank material 30′ is fluidized under pressure and compressed in the axial direction.

Blank material 30′ is thus sized. Sizing of blank material 30′ herein encompasses deformation of blank material 30′ into a necessary shape to adjust a dimension and appropriate adjustment of surface roughness at an end portion of blank material 30′ by smoothing irregularities at the end portion of blank material 30′ caused by cutting of the rolled wire rod described above. In sizing of blank material 30′, blank material 30′ is compressed also in the axial direction. Therefore, strength of blank material 30′ is also collaterally increased. Blank material 30′ may be sized a plurality of times as necessary.

In succession, as shown in FIG. 4, in step ST3, a second end portion of the blank material which is to be an inner end portion of plug 30A is roughly formed. As shown in FIG. 6 (A) to (C), forming dice 121 and 122 as dice and a forming die 123 as a punch are used for rough forming of the second end portion of blank material 30′. A protrusion 123a for providing a second depression portion 35′ which will be described later in blank material 30′ is provided in a forming surface of forming die 123 as the punch.

Specifically, initially, as shown in FIG. 6 (A), blank material 30′ sized in step ST2 is arranged between forming dice 121 and 122 and forming die 123 as being held by a catch 152 of a transfer mechanism. Blank material 30′ is arranged such that the axial direction thereof extends in a direction of alignment of forming dice 121 and 122 and forming die 123.

Then, as shown in FIG. 6 (B), forming die 123 starts to move toward blank material 30′ as it is driven, presses one axial end surface of blank material 30′, and transfers blank material 30′ toward forming dice 121 and 122. Blank material 30′ is released as catch 152 retracts at the time point of insertion of blank material 30′ into an inner space defined by forming dice 121 and 122.

Then, as shown in FIG. 6 (C), forming die 123 further moves toward blank material 30′ so that the other axial end surface of blank material 30′ is in contact with forming die 121 and blank material 30′ is held between forming dice 121 to 123. Pressing force is thus applied to blank material 30′ by forming dice 121 to 123.

Pressing force from forming die 123 is applied to the second end portion of blank material 30′ located on a side of forming die 123. Accordingly, the second end portion of blank material 30′ is fluidized under pressure into a shape corresponding to the forming surface of forming die 123 provided with protrusion 123a, so that second depression portion 35′ having the axial direction of blank material 30′ as a direction of depth is provided in the second end portion. The second end portion of blank material 30′ is thus roughly formed.

In succession, as shown in FIG. 4, in step ST4, a first end portion of the blank material which is to be an outer end portion of plug 30A is finish-formed. As shown in FIG. 7 (A) to (C), a forming die 131 as a die and forming dice 132 and 133 as punches are used for finish-forming the first end portion of blank material 30′. A protrusion 132a in a shape corresponding to second depression portion 35′ provided in the second end portion of blank material 30′ is provided in a forming surface of forming die 132 as the punch, and an annular step portion 133a for forming an outer flange portion 33 in blank material 30′ is provided in a forming surface of forming die 133 as the punch.

Specifically, initially, as shown in FIG. 7 (A), blank material 30′ having the second end portion roughly formed in step ST3 is arranged between forming die 131 and forming dice 132 and 133 as being held by a catch 153 of a transfer mechanism. Blank material 30′ is arranged such that its axial direction extends along a direction of alignment of forming die 131 and forming dice 132 and 133.

Then, as shown in FIG. 7 (B), forming dice 132 and 133 start to move toward blank material 30′ as they are driven, and forming die 132 presses one axial end surface of blank material 30′ and transfers blank material 30′ toward forming die 131. Blank material 30′ is released as catch 153 retracts at the time point of insertion of blank material 30′ into an inner space defined by forming dice 132 and 133.

Then, as shown in FIG. 7 (C), forming dice 132 and 133 further move toward blank material 30′ so that the other axial end surface of blank material 30′ is in contact with forming die 131 and blank material 30′ is held by forming dice 131 to 133. Pressing force is thus applied to blank material 30′ by forming dice 131 to 133.

Pressing force from forming die 131 is applied to the first end portion of blank material 30′ located on the side of forming die 131. Accordingly, the first end portion of blank material 30′ is fluidized under pressure into a shape corresponding to a forming surface of forming die 133 provided with annular step portion 133a so that outer flange portion 33 is formed at the first end portion. The first end portion of blank material 30′ is finish-formed as set forth above.

In succession, as shown in FIG. 4, in step ST5, the second end portion of the blank material which is to be the inner end portion of plug 30A is finish-formed. As shown in FIG. 8 (A) to (C), a forming die 141 as a die and forming dice 142 to 144 as punches are used for finish-forming the second end portion of blank material 30′. In a forming surface of forming die 141 as a die, a protrusion 141a is provided in a portion corresponding to second depression portion 35′ provided in blank material 30′, and forming die 144 as the punch is constituted of a plurality of forming dice resulting from division in a circumferential direction.

Specifically, initially, as shown in FIG. 8 (A), blank material 30′ having the first end portion finish-formed in step ST4 is arranged between forming die 141 and forming dice 142 to 144 as being held by a catch 154 of a transfer mechanism. Blank material 30′ is arranged such that its axial direction extends along a direction of alignment of forming die 141 and forming dice 142 to 144 while it is inverted in the axial direction by catch 154.

Then, as shown in FIG. 8 (B), forming dice 141 and 142 start to move toward blank material 30′ as they are driven, and forming die 142 presses one axial end surface of blank material 30′ and transfers blank material 30′ toward forming die 141. Forming die 144 constituted of divided forming dice is also driven to move in a direction orthogonal to the axial direction of blank material 30′ and abut on the circumferential surface of blank material 30′. Blank material 30′ is released as catch 154 retracts at the time point of insertion of blank material 30′ into an inner space defined by forming dice 142 and 143 and abutment of forming die 144 constituted of the divided forming dice on the circumferential surface of blank material 30′.

Then, as shown in FIG. 8 (C), forming dice 142 to 144 further move toward blank material 30′ so that the other axial end surface of blank material 30′ comes in contact with forming die 141 and blank material 30′ is held by forming dice 141 to 144. Pressing force is thus applied to blank material 30′ by forming dice 141 to 144.

Pressing force from forming die 141 is applied to the second end portion of blank material 30′ located on a side of forming die 141. Accordingly, the second end portion of blank material 30′ is fluidized under pressure into a shape corresponding to a forming surface defined by forming die 141 and forming die 144, so that inner flange portion 34 is formed at the second end portion. The second end portion of blank material 30′ is fluidized under pressure applied by protrusion 141a provided in forming die 141 not only in the axial direction but also radially outward, so that inner flange portion 34 is formed with good formability to project outward from the circumferential surface of blank material 30′. The second end portion of blank material 30′ is finish-formed as set forth above.

Through the steps above, outer flange portion 33 and inner flange portion 34 are formed in blank material 30′ so that plug 30A provided with annular groove portion 32 extending along the circumferential direction in circumferential surface 30c can be manufactured. When the steps above are performed, in addition to outer flange portion 33, inner flange portion 34, and annular groove portion 32 described above, recess 35 is provided in plug 30A.

By thus manufacturing plug 30A only by combination of a plurality of times of heading, as compared with manufacturing by combination of conventional forging and cutting, a cycle time can significantly be shortened and manufacturing cost can significantly be reduced in terms of productivity. In particular, by manufacturing plug 30A by using the single multistep heading machine as above, reduction in cycle time is extremely noticeable and manufacturing cost can drastically be reduced.

Since cutting is not required, cost required for manufacturing facilities can be reduced and plug 30A can be manufactured inexpensively also in this regard. Furthermore, a burr removal operation and a cleaning operation for removing powdery chips which have been required in conventional manufacturing based on combination of forging and cutting are also unnecessary. Therefore, manufacturing cost can be reduced also in this regard.

Additionally, manufacturing of plug 30A only by combination of a plurality of times of heading inevitably increases also the number of times of application of pressure to blank material 30′. Therefore, plug 30A can be equal to or higher than a conventional plug in strength.

By thus adopting a method of manufacturing a plug for gas generator in the present embodiment, manufacturing of a plug for gas generator high in strength capable of achieving significantly lower manufacturing cost than in a conventional example can be achieved.

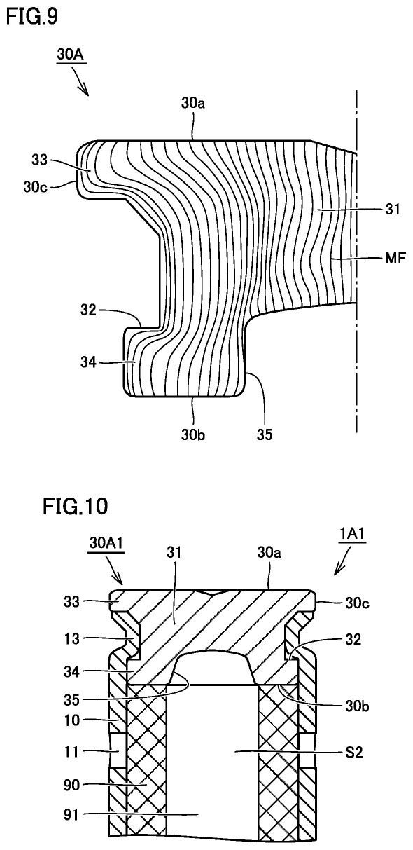

FIG. 9 is a diagram schematically showing how a metal flow appears in a cross-section of the plug for gas generator in the present embodiment. A characteristic structure which appears in plug for gas generator 30A in the present embodiment will now be described in detail.

In general, when a metal material is forged, certain directivity is produced in an internal structure by fluidization under pressure of the metal material, and it appears as a metal flow (which is also referred to as a grain flow). It has been known that a formed product subjected to forging is excellent in shear strength in a direction perpendicular to the metal flow and excellent in tensile strength in a direction in parallel to the metal flow. It has been known that, when there is discontinuity in the metal flow, mechanical strength is low in a portion of discontinuity.

As shown in FIG. 9, plug 30A manufactured in accordance with the method of manufacturing a plug for gas generator in the present embodiment described above has all surfaces including outer end surface 30a, inner end surface 30b, and circumferential surface 30c finish-formed by a plurality of times of heading described above. Therefore, plug 30A has all skins forged, and all metal flows MF formed in plug 30A are formed to reach inner end surface 30b from outer end surface 30a.

Therefore, metal flow MF which appears in a surface layer of circumferential surface 30c including a surface of annular groove portion 32 of plug 30A continuously extends to reach inner end surface 30b from outer end surface 30a along circumferential surface 30c without discontinuity in circumferential surface 30c.

Thus, plug 30A manufactured in accordance with the method of manufacturing a plug for gas generator in the present embodiment does not include discontinuous metal flow MF at any portion. Therefore, the plug is excellent in mechanical strength as a whole.

For providing an annular groove portion in a conventional plug manufactured based on combination of forging and cutting, cutting is used. Therefore, a metal flow is discontinuous at a surface of the annular groove portion. In this regard, the conventional plug can clearly be distinguished from plug 30A manufactured in accordance with the method of manufacturing a plug for gas generator in the present embodiment.

As set forth above, in the conventional plug, a metal flow is discontinuous at the surface of the annular groove portion. Accordingly, production of burrs due to peel-off or curl-up of a part of a surface of the plug is likely. Plug 30A manufactured in accordance with the method of manufacturing a plug for gas generator in the present embodiment, however, is free from such peel-off or curl-up and hence no burr is produced.

Thus, with cylinder type gas generator 1A in the present embodiment described above and plug for gas generator 30A equipped therein and with adoption of the method of manufacturing a plug for gas generator in the present embodiment described above, a plug for gas generator high in strength capable of achieving significantly lower manufacturing cost than in a conventional example and a method of manufacturing the same as well as a gas generator including the plug for gas generator can be obtained.

(First Modification)

FIG. 10 is an enlarged cross-sectional view of the vicinity of a plug for cylinder type gas generator according to a first modification. A cylinder type gas generator 1A1 according to the first modification based on the first embodiment described above and a plug for gas generator 30A1 equipped therein will be described below with reference to FIG. 10.

As shown in FIG. 10, cylinder type gas generator 1A1 according to the present modification is different in construction, that is, in including plug 30A1 different in shape from plug 30A in the first embodiment described above. Specifically, plug 30A1 includes recess 35 having a side surface inclined.

Recess 35 having the side surface inclined is formed in an example where protrusion 141a provided in forming die 141 has an inclined side surface in finish-forming of the second end portion of blank material 30′ described above.

When the second end portion is finish-formed by using a forming die which is provided with a protrusion and has a side surface inclined, the second end portion of the blank material is more likely to be fluidized radially outward and formability of the inner flange portion is further enhanced.

Therefore, when blank material 30′ is particularly hard, in order to enhance formability thereof, plug 30A1 including recess 35 having the side surface inclined is preferably provided.

(Second Modification)

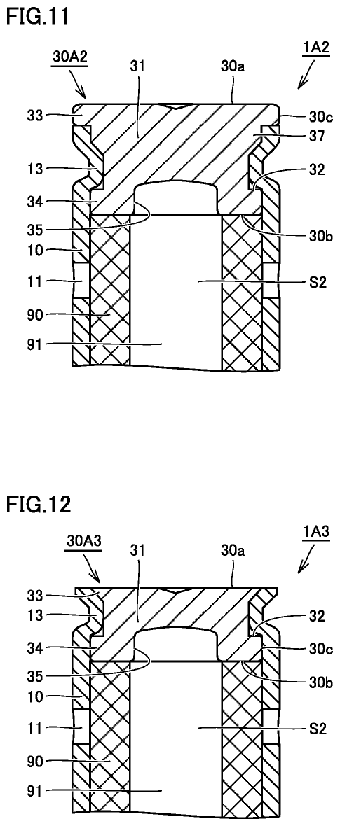

FIG. 11 is an enlarged cross-sectional view of the vicinity of a plug for cylinder type gas generator according to a second modification. A cylinder type gas generator 1A2 according to the second modification based on the first embodiment described above and a plug for gas generator 30A2 equipped therein will be described below with reference to FIG. 11.

As shown in FIG. 11, cylinder type gas generator 1A2 according to the present modification is different in construction, that is, in including plug 30A2 different in shape from plug 30A in the first embodiment described above. Specifically, plug 30A2 includes a straight portion 37 between annular groove portion 32 provided in circumferential surface 30c and outer flange portion 33.

According to such a construction, housing main body 10 can be arranged to cover straight portion 37, so that an area of contact between housing main body 10 and plug 30A2 can be increased. Therefore, consequently, a distance between filter chamber S2 and a space outside the housing can be increased and hermeticity of that portion can be enhanced.

(Third Modification)

FIG. 12 is an enlarged cross-sectional view of the vicinity of a plug for cylinder type gas generator according to a third modification. A cylinder type gas generator 1A3 according to the third modification based on the first embodiment described above and a plug for gas generator 30A3 equipped therein will be described below with reference to FIG. 12.

As shown in FIG. 12, cylinder type gas generator 1A3 according to the present modification is different in construction, that is, in including plug 30A3 different in shape from plug 30A in the first embodiment described above. Specifically, plug 30A3 is constructed such that outer flange portion 33 is smaller in outer diameter and is in a substantially triangular shape in a cross-sectional view.

More specifically, outer flange portion 33 is constructed to substantially be equal in outer diameter to inner flange portion 34, and the outer diameters of outer flange portion 33 and inner flange portion 34 are substantially equal to the inner diameter of housing main body 10 in a portion other than portions where swaging portions 12 and 13 are formed. Outer flange portion 33 does not include an annular portion in a form of a flat plate equal in thickness in the axial direction of plug 30A, so that it is constructed in a substantially triangular shape in the cross-sectional view.

According to such a construction as well, annular groove portion 32 is provided in circumferential surface 30c in a portion located between outer flange portion 33 and inner flange portion 34. Therefore, so long as annular groove portion 32 is provided in circumferential surface 30c, a shape or a size of outer flange portion 33 and inner flange portion 34 may be modified in any manner.

### Second Embodiment

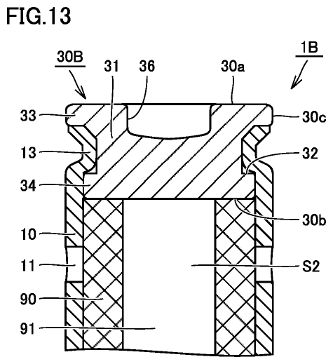

FIG. 13 is an enlarged cross-sectional view of the vicinity of a plug for cylinder type gas generator in a second embodiment of the present invention. A cylinder type gas generator 1B in the present embodiment and a plug for gas generator 30B equipped therein will be described below with reference to FIG. 13.

As shown in FIG. 13, cylinder type gas generator 1B in the present embodiment is different in construction, that is, in including plug 30B different in shape from plug 30A in the first embodiment described above. Specifically, plug 30B does not include a recess in inner end surface 30b but includes a recess 36 in a central portion of outer end surface 30a.

Plug 30B in such a shape can also be manufactured with a manufacturing method in conformity with the method of manufacturing a plug for gas generator described in the first embodiment above. Specifically, plug 30B can be manufactured by initially cutting a rolled wire rod, then sizing a blank material, then forming a first depression portion having the axial direction of the blank material as a direction of depth in the outer end surface by roughly forming the outer end portion, then forming the outer flange portion by finish-forming the outer end portion, and then forming the inner flange portion by finish-forming the inner end portion. In this case, the first depression portion finally provided as recess 36 can be provided in the blank material by using a forming die including a protrusion in a forming surface in roughly forming the outer end portion.

Thus, with cylinder type gas generator 1B in the present embodiment and plug for gas generator 30B equipped therein and with adoption of the method of manufacturing a plug for gas generator in the present embodiment described above, a plug for gas generator high in strength capable of achieving significantly lower manufacturing cost than in a conventional example and a method of manufacturing the same as well as a gas generator including the plug for gas generator can be obtained.

In the embodiments of the present invention and the modifications thereof described above, not only the construction of the cylinder type gas generator in a portion where the plug is assembled but also the construction of the cylinder type gas generator in a portion other than the portion where the plug is assembled are described in detail with reference to an example thereof. The construction of the cylinder type gas generator in the portion other than the portion where the plug is assembled, however, is not limited thereto and modification thereto can naturally be made.

In the embodiments of the present invention and the modifications thereof described above, the plug provided with a recess in any one of the outer end surface and the inner end surface is described by way of example. A recess, however, may be provided in both of the outer end surface and the inner end surface or a recess may be provided in neither of the outer end surface and the inner end surface.

In the embodiments of the present invention described above, an example in which a plug is manufactured by performing heading a plurality of times by using a single multistep heading machine is described. The plug, however, may be manufactured by using a plurality of heading machines or by performing forging other than heading. In forging, cold forging or hot forging may be performed. From a point of view of enhancing precision of components, heading or cold forging is preferred.

As shown in the embodiments of the present invention described above, a construction of a forming die including a die and a punch or a construction of a transfer mechanism can be modified as appropriate even in manufacturing a plug by performing heading a plurality of times with the use of a single multistep heading machine, and the order of steps can be modified as appropriate without departing from the gist of the present invention.

In addition, though an example in which the present invention is applied to a cylinder type gas generator incorporated in a side air bag apparatus is illustrated and described in the embodiments of the present invention described above, applications of the present invention are not limited thereto and the present invention can be applied also to a cylinder type gas generator incorporated in a curtain air bag apparatus, a knee air bag apparatus, or a seat cushion air bag apparatus or what is called a T-shaped gas generator having an elongated outer geometry similarly to the cylinder type gas generator.

The embodiments and the modifications thereof disclosed herein are thus illustrative and non-restrictive in every respect. The technical scope of the present invention is delimited by the terms of the claims, and includes any modifications within the scope and meaning equivalent to the terms of the claims.

### REFERENCE SIGNS LIST

1A, 1A1 to 1A3, 1B cylinder type gas generator; 10 housing main body; 11 gas discharge opening; 12, 13 swaging portion; 20 holder; 21 through portion; 22 annular groove portion; 23 swaging portion; 24 recess; 30A, 30A1 to 30A3, 30B plug; 30′ blank material; 30a outer end surface; 30b inner end surface; 30c circumferential surface; 31 body portion; 32 annular groove portion; 33 outer flange portion; 34 inner flange portion; 35, 36 recess; 35′ second depression portion; 37 straight portion; 40 igniter; 41 ignition portion; 42 terminal pin; 43 combustion control cover; 50 partition member; 51 separation wall portion; 51a score; 52 annular wall portion; 60 coil spring, 70 gastight container; 71 cup body; 71a top wall portion; 71b sidewall portion; 71b1 opening end; 72 cover body; 72a bottom portion; 72b fold-over portion; 80 gas generating agent; 81 autoignition agent; 82 division member; 83 coil spring; 83a spring portion; 83b pressing portion; 90 filter; 91 hollow portion; 111 to 113, 121 to 123, 131 to 133, 141 to 144 forming die; 123a, 132a, 141a protrusion; 133a annular step portion; 151 to 154 catch; MF metal flow; S1 combustion chamber; S1A gas generating agent accommodation chamber; S1B heat insulating layer; and S2 filter chamber

1. A gas generator comprising:
an elongated cylindrical housing main body provided with a gas discharge opening;
a gas generating agent accommodated in the housing main body;
a holder which closes one axial end of the housing main body, to which an igniter serving to burn the gas generating agent is assembled; and
a plug which closes the other axial end of the housing main body,
the plug being formed from a substantially disc-shaped member made of a metal, the member including a first end surface and a second end surface located as being opposed to each other and a circumferential surface connecting the first end surface and the second end surface to each other,
the plug including a substantially columnar body portion, a first flange portion projecting radially outward from an axial end portion of the body portion located on a side of the first end surface, and a second flange portion projecting radially outward from an axial end portion of the body portion located on a side of the second end surface,
an annular groove portion defined by the body portion, the first flange portion, and the second flange portion being located in the circumferential surface,
the plug being inserted in the other end of the housing main body such that any one of the first end surface and the second end surface faces inside of the housing main body and the circumferential surface faces an inner circumferential surface of the housing main body and fixed by swaging to the housing main body by decreasing a diameter of the housing main body radially inward in a portion corresponding to the annular groove portion to engage the housing main body with the annular groove portion,
a metal flow in a portion which appears in a surface layer of the circumferential surface including a surface of the annular groove portion continuously extending to reach the second end surface from the first end surface along the circumferential surface without discontinuity in the circumferential surface.

2. The gas generator according to claim 1, wherein
a recess is provided in at least any one of the first end surface and the second end surface.

3. A plug for gas generator substantially in a form of a disc made of a metal, the plug including a first end surface and a second end surface located as being opposed to each other and a circumferential surface connecting the first end surface and the second end surface to each other, the plug comprising:
a substantially columnar body portion;
a first flange portion projecting radially outward from an axial end portion of the body portion located on a side of the first end surface; and
a second flange portion projecting radially outward from an axial end portion of the body portion located on a side of the second end surface,
an annular groove portion defined by the body portion, the first flange portion, and the second flange portion being located in the circumferential surface,
a metal flow in a portion which appears in a surface layer of the circumferential surface including a surface of the annular groove portion continuously extending to reach the second end surface from the first end surface along the circumferential surface without discontinuity in the circumferential surface.

4. The plug for gas generator according to claim 3, wherein
a recess is provided in at least any one of the first end surface and the second end surface.

5. A method of manufacturing a plug for gas generator in a form of a disc made of a metal, the plug including a first end surface and a second end surface located as being opposed to each other and a circumferential surface connecting the first end surface and the second end surface to each other, the plug being provided with an annular groove portion extending along a circumferential direction in the circumferential surface, the method comprising:
forming a substantially columnar blank material by cutting a rolled wire rod as intersecting with an axial direction;
sizing the blank material; and
providing the annular groove portion in a circumferential surface of the sized blank material,
the providing the annular groove portion including
finish-forming a first end portion representing one axial end portion of the blank material and including the first end surface by forming a first flange portion which projects radially outward in the first end portion by fluidizing the first end portion under pressure, and
finish-forming a second end portion representing the other axial end portion of the blank material and including the second end surface by forming a second flange portion which projects radially outward in the second end portion by fluidizing the second end portion under pressure while a plurality of forming dice divided in a circumferential direction are applied to the circumferential surface of the blank material after finish-forming of the first end portion.

6. The method of manufacturing a plug for gas generator according to claim 5, wherein
the providing the annular groove portion further includes roughly forming the first end portion by providing a first depression portion having an axial direction of the blank material as a direction of depth in the first end portion by fluidizing the first end portion of the blank material under pressure before finish-forming of the first end portion, and
the first end portion is finish-formed by fluidizing the first end portion under pressure by using a forming die provided with a protrusion which can be inserted into the first depression portion in the finish-forming a first end portion.

7. The method of manufacturing a plug for gas generator according to claim 6, wherein
the providing the annular groove portion further includes roughly forming the second end portion by providing a second depression portion having an axial direction of the blank material as a direction of depth in the second end portion by fluidizing the second end portion of the blank material under pressure before finish-forming of the second end portion, and
the second end portion is finish-formed by fluidizing the second end portion under pressure by using a forming die provided with a protrusion which can be inserted into the second depression portion in the finish-forming a second end portion.

8. The method of manufacturing a plug for gas generator according to claim 7, wherein
the sizing the blank material and the providing the annular groove portion are both performed by heading.

9. The method of manufacturing a plug for gas generator according to claim 8, wherein
the forming a blank material, the sizing the blank material, and the providing the annular groove portion are performed by using a single multistep heading machine.

10. The method of manufacturing a plug for gas generator according to claim 5, wherein
the sizing the blank material and the providing the annular groove portion are both performed by heading.

11. The method of manufacturing a plug for gas generator according to claim 10, wherein
the forming a blank material, the sizing the blank material, and the providing the annular groove portion are performed by using a single multistep heading machine.

12. The method of manufacturing a plug for gas generator according to claim 6, wherein
the sizing the blank material and the providing the annular groove portion are both performed by heading.

13. The method of manufacturing a plug for gas generator according to claim 12, wherein
the forming a blank material, the sizing the blank material, and the providing the annular groove portion are performed by using a single multistep heading machine.

14. The method of manufacturing a plug for gas generator according to claim 5, wherein
the providing the annular groove portion further includes roughly forming the second end portion by providing a second depression portion having an axial direction of the blank material as a direction of depth in the second end portion by fluidizing the second end portion of the blank material under pressure before finish-forming of the second end portion, and
the second end portion is finish-formed by fluidizing the second end portion under pressure by using a forming die provided with a protrusion which can be inserted into the second depression portion in the finish-forming a second end portion.

15. The method of manufacturing a plug for gas generator according to claim 14, wherein
the sizing the blank material and the providing the annular groove portion are both performed by heading.

16. The method of manufacturing a plug for gas generator according to claim 15, wherein
the forming a blank material, the sizing the blank material, and the providing the annular groove portion are performed by using a single multistep heading machine.
